(19) United States
(12) Patent Application Publication
(10) Pub. No.: US 2005/0175042 A1
(43) Pub. Date: Aug. 11, 2005

(54) Method for enabling high-brightness, narrow-band orbital radiation to be utilized simultaneously on a plurality of beam lines

(75) Inventor: Ryoichi Hajima, Kyoto (JP)

Correspondence Address: BANNER & WITCOFF, 1001 G STREET N W, SUITE 1100, WASHINGTON, DC, 20001, US

(73) Assignee: Japan Atomic Energy Research Institute, Kashiwa-shi (JP)

(21) Appl. No.: 11/049,755

(22) Filed: Feb. 4, 2005

(30) Foreign Application Priority Data
Feb. 10, 2004 (JP) 2004-033225

(51) Int. Cl. H01S 3/00

(52) U.S. Cl. 372/2

(57) ABSTRACT

In an electron accelerator such as an electron storage ring, a linac or an energy-recovery linac, accelerated electron bunches are subjected to light-electron interaction to have a varying profile of electron density and the thus modulated electron bunches are passed between deflecting magnets or injected into an undulator to generate high-brightness, narrow-band orbital radiation, thereby enabling high-brightness, narrow-band orbital radiation to be utilized simultaneously on a plurality of beam lines.

### BACKGROUND OF THE INVENTION

This invention relates to a method which enables high-brightness, narrow-band orbital radiation to be utilized simultaneously on a plurality of beam lines (sites of use) provided in whatever type of electron accelerator whether it be an electron storage ring, a linac or an energy-recovery linac.

Electrons accelerated to high enough energy by means of an electron storage ring or an energy-recovery linac can emit orbital radiation (synchrotron or undulator radiation) which has high brightness and directivity in ultraviolet to X-ray wavelength regions. In addition, orbital radiation can be utilized simultaneously on a plurality of beam lines.

Synchrotron radiation or undulator radiation is directional in that radiation of electromagnetic wave (light) is concentrated in the forward direction (in which electrons travel). Synchrotron radiation is the emission of electromagnetic wave (light) which is observed when electrons accelerated to high enough energy are bent by a magnetic field and a typical example is the radiation from deflecting magnets in an electron storage ring. Undulator radiation is generated when electrons are allowed to wiggle periodically at small amplitude by means of magnets combined in a particular configuration.

As shown in FIG. 1, the electron storage ring causes accelerated electrons from an injector to be circulated and stored so that by means of deflecting magnets or an undulator provided on the ring, isolated beams of radiation are generated from the stored electrons in a direction tangential to the electron orbit.

The principle of the energy-recovery linac is shown in FIG. 3 for the case where no FEL oscillator is used. Electron bunches from an injector (linac) are passed through a main linear accelerator (linac) to generate an accelerated electron beam which, after being used to generate undulator radiation, is re-injected into the main accelerator which acts this time as a decelerator. The energy of the re-injected electrons is converted to RF power which can be recycled for accelerating succeeding electron bunches. This process contributes to improving the overall power efficiency of the device. Energy conversion from the electron beam to RF power can be realized by re-injecting electron bunches into the main linac 180 degrees out of phase with the first injection.

The free-electron laser (FEL) can produce light having an extremely high brightness and a narrow wavelength band (temporal coherence) in a broad range from infrared to X-rays. On the other hand, it has the disadvantage that it cannot be utilized simultaneously on a plurality of beam lines.

The operating principle of FEL is shown in FIG. 2. An electron beam accelerated in an accelerator is injected into an undulator, where it is subjected to wiggling motion in a magnetic field and emits undulator radiation, which is allowed to move back and forth between mirrors in an optical resonator so that it interacts with electron bunches repeatedly to generate amplified laser.

### SUMMARY OF THE INVENTION

The present invention enables high-brightness, narrow-band orbital radiation to be utilized simultaneously on a plurality of beam lines (sites of use) in a single apparatus (electron accelerator). By the word “single” is meant a single unit and according to the invention, there is no need to install more than one unit of accelerator and a single unit of accelerator suffices to provide high-brightness, narrow-band radiation on a plurality of beam lines.

The present invention principally provides such a method that in a single electron accelerator in an electron storage ring, linac, energy-recovery linac, etc., accelerated electron bunches (comprising a multitude of electrons) are subjected to light-electron interaction to have a varying profile of electron density and the thus modulated electron bunches are passed between deflecting magnets or injected into an undulator to generate high-brightness, narrow-band orbital radiation, thereby enabling the orbital radiation to be utilized simultaneously on a plurality of beam lines.

The present invention has such versatility that it can be utilized to produce high-brightness, narrow-band orbital radiation in whatever type of electron accelerator whether it be an electron storage ring, a linac or an energy-recovery linac.

### BRIEF DESCRIPTION OF THE DRAWINGS

FIG. 1 shows an apparatus for generating orbital radiation using a storage ring;

FIG. 2 shows a free-electron laser apparatus;

FIG. 3 shows an apparatus in which the concept of the present invention is applied to an energy-recovery linac;

FIG. 4 shows the spectrum of radiation emitted from deflecting magnets in an apparatus adopting the concept of the present invention;

FIG. 5 shows an apparatus in which the concept of the present invention is applied to a linac; and

FIG. 6 shows an apparatus in which the concept of the present invention is applied to a storage ring.

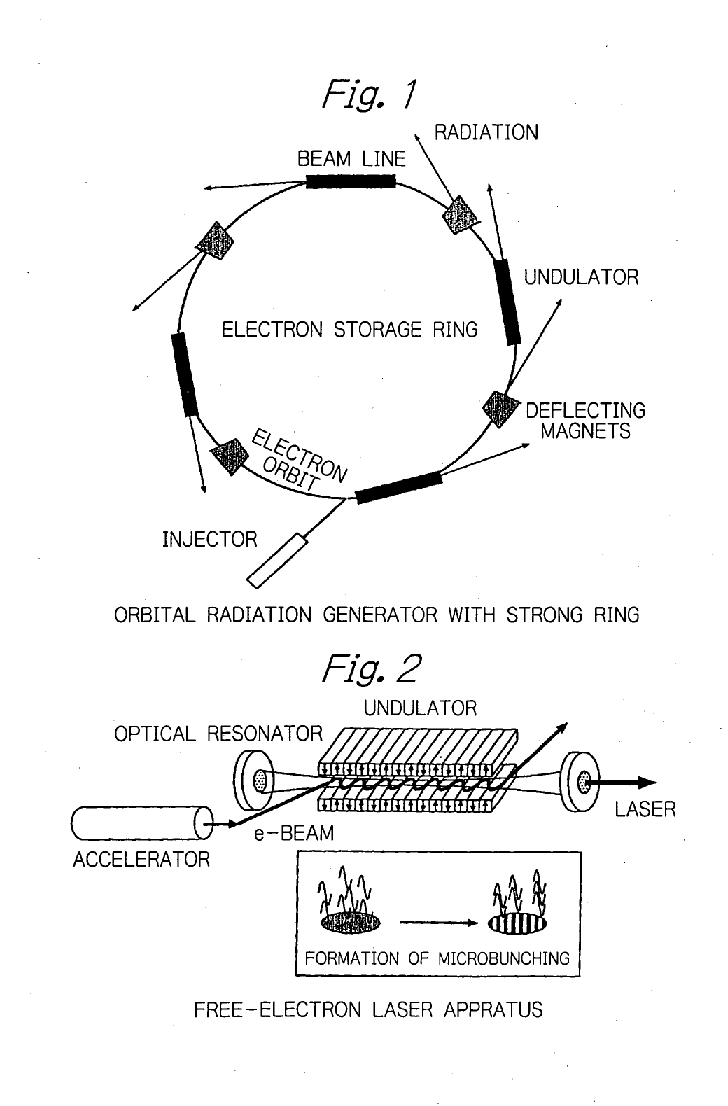

### DETAILED DESCRIPTION OF THE INVENTION

(1) Free-Electron Laser Apparatus (FEL Resonator)

As shown in FIG. 2, the light-electron interaction occurring in a free-electron laser resonator allows electron bunches (comprising a multitude of electrons) to have a varying profile of electron density, the interval of which is equal to the wavelength of light. If the thus modulated electron bunches are directed to pass between deflecting magnets or injected into an undulator, synchrotron radiation or undulator radiation is emitted as it is intensified by the interference from the modulation of electron density at a radiation wavelength equal to the oscillation wavelength of the free-electron laser. The interference-induced intensity enhancement of radiation is equal to the number of electrons in their bunches.

The wavelength band of the radiation is determined by the repetition number of electron density modulation (which in turn is approximately equal to the number of undulator periods in the free-electron laser), so narrow-band radiation can also be obtained from the deflecting magnets or the undulator with small number of periods.

The wavelength band (wavelength spectrum) of synchrotron radiation or undulator radiation is determined by the electron energy and the geometric shape parameters of electron orbit (its radius and the undulator frequency). In synchrotron radiation from the deflecting magnets, one can only produce a spectrum of smooth profile having a cutoff at the higher-energy (shorter-wavelength) end, as indicated by the dashed line in FIG. 4. This is a broad-band radiation.

Speaking of synchrotron radiation and undulator radiation which result from electron bunches maintaining the modulation in electron density that was created in the free-electron laser (FEL), the radiation emitted from one electron is superposed on the radiation emitted from another electron and on account of phase matching that results from “microbunching”, the wavelength band of the finally obtained radiation is narrow. In this phase-matching phenomenon, the light emitted from a multitude of electrons has the same phase relationship (peak-to-peak and valley-to-valley), so it is intensified with an observed constancy in wavelength. The degrees of light intensification and wavelength band narrowing are determined by the modulation of electron density in electron bunches and, hence, by the configuration of the free-electron laser per se. As a matter of fact, one can obtain a wavelength band narrower than what is determined by the geometric shapes of the deflecting magnets and the undulator located at the positions for radiation emission.

Speaking further of the free-electron laser resonator, it must have a site for picking up the oscillated laser light externally (to the outside of the optical resonator) and, as shown in FIG. 2, a partial transmitting mirror is conventionally provided to transmit a portion of the laser light. However, in the 13-nm EUV region which is to be employed in next-generation photolithography, there is no such partial transmitting mirror, making it difficult to realize an ordinary free-electron laser. This problem is solved by the method of the present invention and an ordinary free-electron laser can be operated. It should be further noted that the optical resonator shown in FIG. 2 confines the undulator radiation between two reflector mirrors and causes it to interact with electrons repeatedly so that a varying profile of electron density is created to yield intense radiation (laser).

(2) FEL Resonator as Applied to an Electron Storage Ring

In a storage ring of the type shown in FIG. 6, an accelerated electron beam from an injector is further accelerated in an accelerating cavity and, after being circulated and stored in the ring, the beam is introduced into an FEL resonator and the resulting electron bunches are modulated to have a varying profile of electron density, the interval of which is equal to the wavelength of light and the thus modulated electron bunches are passed between the deflecting magnets or injected into the undulator provided on the electron orbit so that on account of the interference resulting from the modulation in electron density, enhanced synchrotron radiation or undulator radiation is generated at a wavelength equal to the oscillation wavelength of the free-electron laser. The thus generated light is high-brightness, narrow-band orbital radiation that is enhanced in brightness by the electronic interference.

(3) FEL Resonator as Applied to a Linac

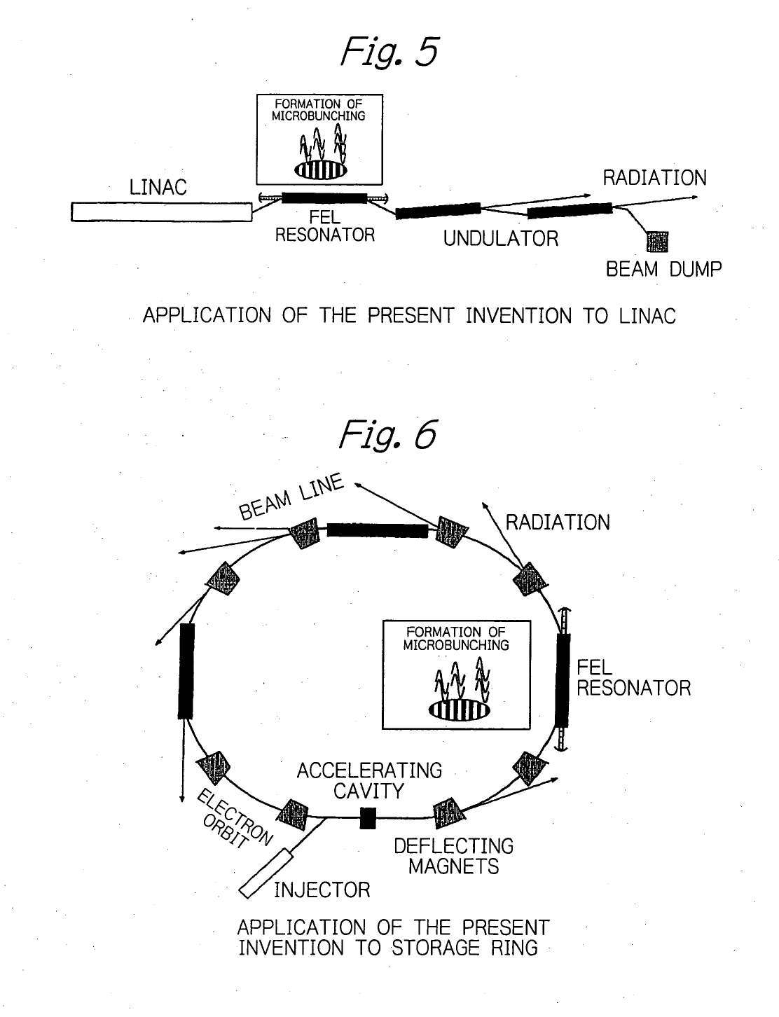

In a linac of the type shown in FIG. 5, an accelerated electron beam from a linear accelerator (linac) is introduced into an FEL resonator and the resulting electron bunches are modulated to have a varying profile of electron density, the interval of which is equal to the wavelength of light and the thus modulated electron bunches are injected into the undulator so that on account of the interference resulting from the modulation in electron density, enhanced undulator radiation is generated at a wavelength equal to the oscillation wavelength of the free-electron laser. The thus generated light is high-brightness, narrow-band orbital radiation that is enhanced in brightness by the electronic interference. The beam dump shown in FIG. 5 is an electron beam stopping (dumping) device which is typically an air- or water-cooled metal block.

(4) FEL Resonator as Applied to an Energy-Recovery Linac

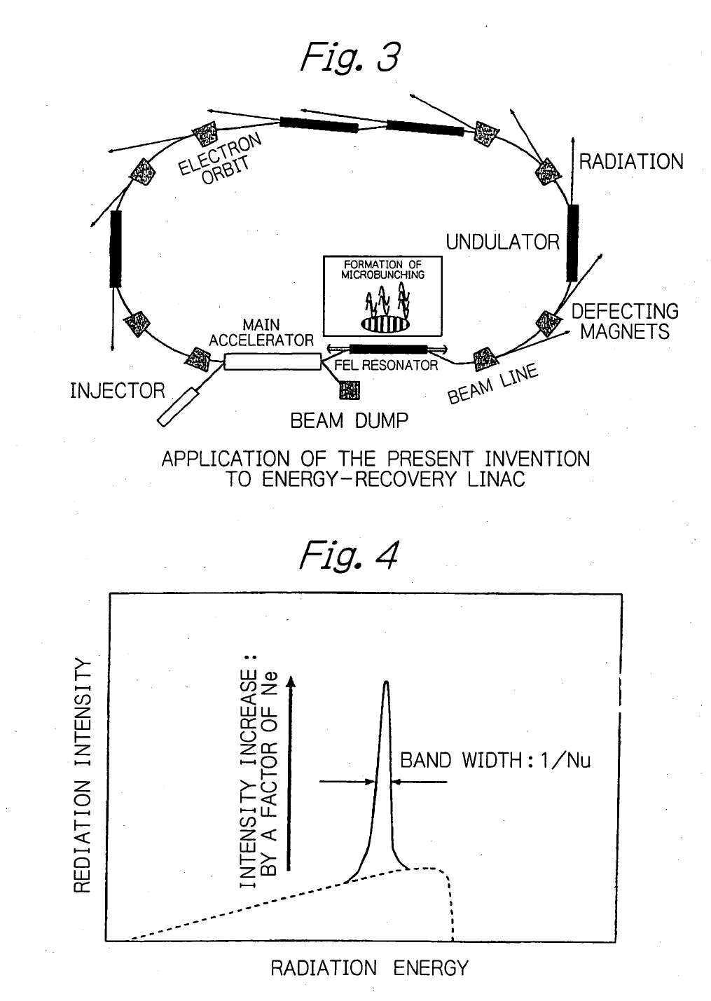

In an energy-recovery linac of the type shown in FIG. 3, an accelerated electron beam from an injector is further accelerated in a main accelerator, then introduced into an FEL resonator and the resulting electron bunches are modulated to have a varying profile of electron density, the interval of which is equal to the wavelength of light and the thus modulated electron bunches are passed between the deflecting magnets or injected into the undulator provided on the electron orbit so that on account of the interference resulting from the modulation in electron density, enhanced synchrotron radiation or undulator radiation is generated at a wavelength equal to the oscillation wavelength of the free-electron laser; the electron beam is returned into the main accelerator and its energy is converted to RF power which is recycled to accelerate ensuing electron bunches. The thus generated light is high-brightness, narrow-band orbital radiation that is enhanced in brightness by the electronic interference.

### EXAMPLE

FIG. 4 shows two spectra of radiation, one from deflecting magnets in an apparatus not employing the present invention and the other from deflecting magnets in an apparatus employing the present invention. The former is indicated by the dashed line and the latter by the solid line.

With the apparatus that employs the present invention, the spectrum intensity is increased by a factor of Ne or the number of electrons in bunches whereas the band width is given by the reciprocal of Nu or the number of undulator periods in the free-electron laser oscillator.

1. A method for enabling high-brightness, narrow-band orbital radiation to be utilized simultaneously on a plurality of beam lines in an electron storage ring, a linac or an energy-recovery linac, which comprises subjecting accelerated electron bunches to light-electron interaction to have a varying profile of electron density and passing the thus modulated electron bunches between deflecting magnets or injecting them into an undulator to generate high-brightness, narrow-band orbital radiation.

2. The method according to claim 1, wherein in an electron storage ring, an accelerated electron beam from an injector is further accelerated in an accelerating cavity and, after being circulated and stored in the ring, the beam is introduced into an FEL resonator and the resulting electron bunches are modulated to have a varying profile of electron density, the interval of which is equal to the wavelength of light and the thus modulated electron bunches are passed between the deflecting magnets or injected into the undulator so that on account of the interference resulting from the modulation in electron density, enhanced synchrotron radiation or undulator radiation is generated at a wavelength equal to the oscillation wavelength of the free-electron laser.

3. The method according to claim 1, wherein in a linac or linear accelerator, an accelerated electron beam from the linac is introduced into an FEL resonator and the resulting electron bunches are modulated to have a varying profile of electron density, the interval of which is equal to the wavelength of light and the thus modulated electron bunches are passed between the deflecting magnets or injected into the undulator so that on account of the interference resulting from the modulation in electron density, enhanced synchrotron radiation or undulator radiation is generated at a wavelength equal to the oscillation wavelength of the free-electron laser.

4. The method according to claim 1, wherein in an energy-recovery linac or linear accelerator which recycles the RF energy of a returned electron beam to accelerate ensuing electron bunches, an accelerated electron beam from an injector is further accelerated in a main accelerator, then introduced into an FEL resonator and the resulting electron bunches are modulated to have a varying profile of electron density, the interval of which is equal to the wavelength of light and the thus modulated electron bunches are passed between the deflecting magnets or injected into the undulator so that on account of the interference resulting from the modulation in electron density, enhanced synchrotron radiation or undulator radiation is generated at a wavelength equal to the oscillation wavelength of the free-electron laser.
